(19) United States
(12) Patent Application Publication
(10) Pub. No.: US 2016/0139850 A1
(43) Pub. Date: May 19, 2016

(54) MANAGING METHOD OF STORAGE DEVICE, COMPUTER SYSTEM AND STORAGE MEDIUM

(71) Applicant: Kabushiki Kaisha Toshiba, Tokyo (JP)

(72) Inventors: Taichi Ejiri, Yokohama Kanagawa (JP); Masamitsu Ohhashi, Yokohama Kanagawa (JP); Masaki Saito, Yokohama Kanagawa (JP); Takeyuki Minamimoto, Tachikawa Tokyo (JP); Teruji Yamakawa, Tokyo (JP)

(21) Appl. No.: 14/642,183

(22) Filed: Mar. 9, 2015

Related U.S. Application Data
(60) Provisional application No. 62/079,373, filed on Nov. 13, 2014.

(51) Int. Cl. G06F 3/06; G06F 12/14; G06F 9/50

(52) U.S. Cl. CPC G06F 3/0644; G06F 9/5077; G06F 3/0673; G06F 3/0626; G06F 12/14; G06F 2212/1052

(57) ABSTRACT

According to one embodiment, a managing method of a storage device including a storage unit capable of being divided into a plurality of storage areas, and being capable of setting an access restriction for each of the storage areas, the method includes setting access restriction information on the access restriction to a desired one of the storage areas, and setting predetermined information which indicates whether the desired storage area is accessible or not and which is capable of being recognized by a host system.

### CROSS-REFERENCE TO RELATED APPLICATIONS

This application claims the benefit of U.S. Provisional Application No. 62/079,373, filed Nov. 13, 2014, the entire contents of which are incorporated herein by reference.

### FIELD

Embodiments described herein relate generally to a managing method of a storage device, a computer system, and a storage medium.

### BACKGROUND

There are access restriction functions per partition or per file or folder for storage devices from operating systems (OS). These access restrictions are access restriction functions by the OSs. Thus, the storage devices can be accessed by issuing write commands or read commands to which the storage devices can respond.

Therefore, products in which the storage devices themselves have access restriction functions, such as TCG Enterprise SSC and TCG Opal SSC, have been developed. Such access restriction functions by the storage devices have higher security, because if the functions are valid, the storage devices do not respond to read commands or write commands to which they can respond. In the storage devices having access restriction functions, such as TCG Enterprise SSC or TCG Opal SSC, access restriction can be performed per storage area.

However, existing OSs are not intended for access restriction per storage area divided by the access restriction functions of the storage devices. Thus, if access restrictions are put on the storage devices per storage area, there will be a mismatch between the storage devices and the OSs.

Therefore, it has been desired to properly manage the storage devices having access restriction functions.

### BRIEF DESCRIPTION OF THE DRAWINGS

FIG. 1 is a block diagram showing a basic structure of a computer system according to a first embodiment;

FIG. 2 is an illustration schematically showing an access method to a storage device in storage management software according to the first embodiment;

FIG. 3 is an illustration schematically showing a structure of a storage unit according to the first embodiment;

FIG. 4 is a flowchart showing a method of the first embodiment;

FIG. 5 is an illustration showing an example of partition information according to the first embodiment;

FIG. 6 is an illustration showing an example of display content on a display according to the first embodiment;

FIG. 7 is an illustration schematically showing an access method to a storage device in storage management software according to a second embodiment;

FIG. 8 is a flowchart showing operation at the time of booting a removable-disk-setting driver according to the second embodiment;

FIG. 9 is a flowchart showing a method of the second embodiment; and

FIG. 10 is an illustration showing an example of partition information and a state of a removable disk according to the second embodiment.

### DETAILED DESCRIPTION

In general, according to one embodiment, a managing method of a storage device comprising a storage unit capable of being divided into a plurality of storage areas, and being capable of setting an access restriction for each of the storage areas, the method includes: setting access restriction information on the access restriction to a desired one of the storage areas; and setting predetermined information which indicates whether the desired storage area is accessible or not and which is capable of being recognized by a host system.

Embodiments will be described hereinafter with reference to the accompanying drawings.

### First Embodiment

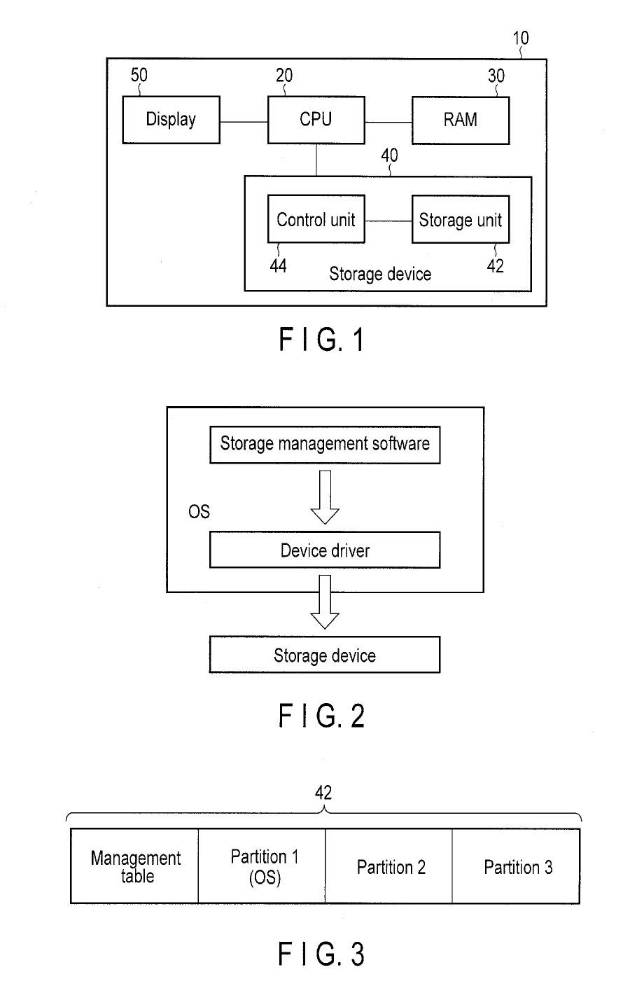

FIG. 1 is a block diagram showing a basic structure of a computer system 10 according to the present embodiment. The structure shown in FIG. 1 is mounted on, for example, a personal computer.

The system 10 of FIG. 1 comprises a CPU (processor) 20, a RAM 30, a storage device 40, and a display 50.

The storage device 40 comprises a storage unit 42 which stores various kinds of information and is divisible into storage areas, and a control unit 44 which controls the storage unit 42. In the storage device 40, an access restriction can be set for each of the storage areas into which the storage unit 42 is divided. An access restriction function includes, for example, TCG Opal SSC and TCG Enterprise SSC.

The storage device 40 is, for example, a hard disk drive (HDD) device or a solid state drive (SSD) device. If the storage device 40 is an HDD, the storage unit 42 corresponds to a magnetic disk. If the storage device 40 is an SSD, the storage unit 42 corresponds to a nonvolatile semiconductor memory.

In the storage unit 42, an operating system (OS) such as Windows (registered trademark) is stored. In addition, in the storage unit 42, storage management software which will be described later is stored. In the present embodiment, the storage management software operates on the OS.

FIG. 2 is an illustration schematically showing an access method to the storage device 40 in the storage management software. The storage management software accesses the storage device via a device driver included in the OS.

FIG. 3 is an illustration schematically showing a structure (layout) of the storage unit 42. The storage unit 42 includes partitions (partitions 1 to 3) to be storage areas and a management table for managing the partitions. The partition 1 includes the OS.

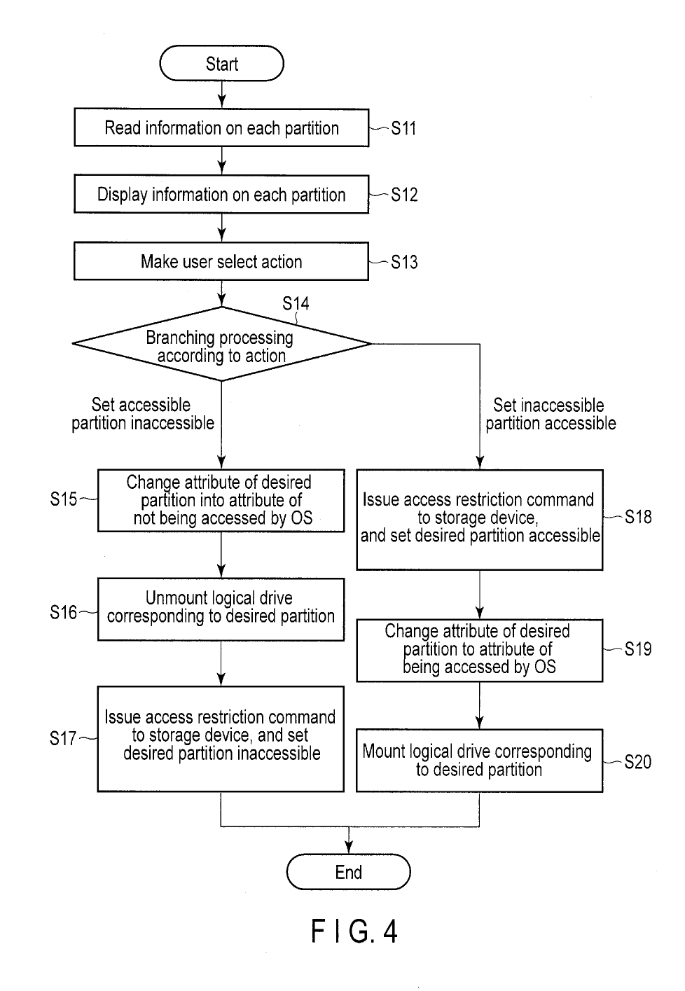

FIG. 4 is a flowchart showing a method (a managing method of a storage device) of the present embodiment. The processing of the flowchart of FIG. 4 is performed mainly on the basis of the storage management software.

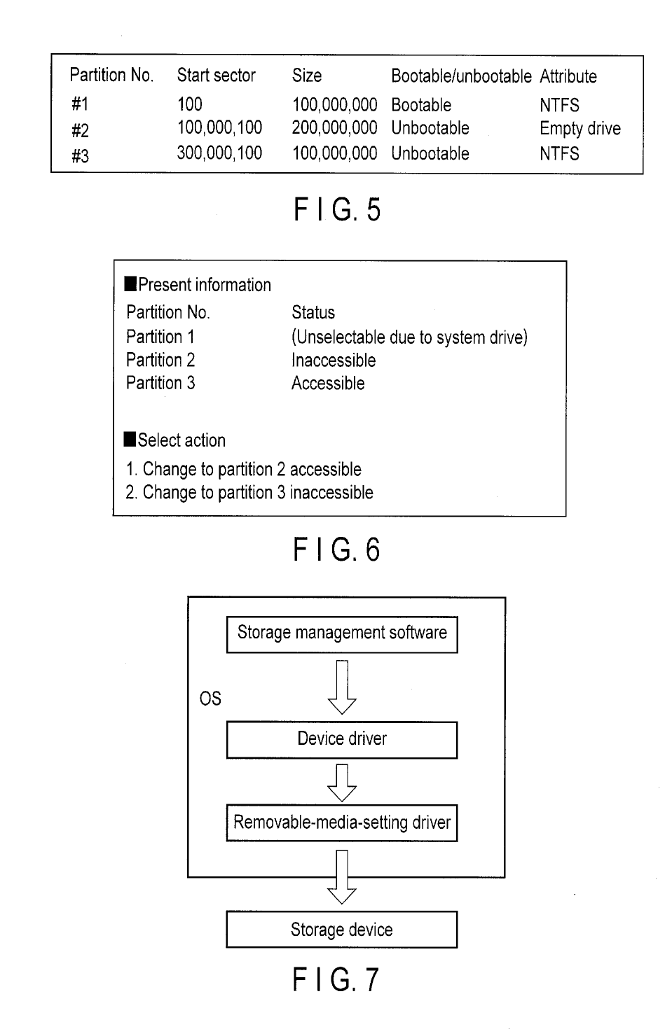

First, when the system is booted, information on each partition stored in the management table is read (S11). More specifically, information such as a start sector, the size of an area, bootability or unbootability, and an attribute of a partition, is read. FIG. 5 is an illustration showing an example of partition information.

Next, information on each partition is displayed on the display 50 (S12). FIG. 6 is an illustration showing an example of display content on the display. Here, if an attribute of a partition indicates a file system accessed by the OS, such as “NTFS” or “FAT”, it is considered that an access restriction is not put on the partition. That is, the partition is considered accessible. If an attribute of a partition indicates a file system which is not accessed by the OS of the present embodiment, such as “empty drive” or “Linux (registered trademark) file system”, it is considered that an access restriction is put on the partition. That is, the partition is considered inaccessible.

Next, a user is made to select a desired action on the basis of display content on the display (S13).

Then, branching processing according to an action selected by the user is performed (S14). More specifically, mainly the following two processes are performed in each processing after branching.

A first process is to set access restriction information on an access restriction of the storage device for a desired partition (storage area). The access restriction information is information on whether the desired partition is set accessible or is set inaccessible.

A second process is to set predetermined information which indicates whether the desired partition (storage area) is accessible or not and is recognizable by a host system. In the present embodiment, the predetermined information is information on an attribute of the desired partition. The predetermined information is set as a part of management information in the management table (see FIG. 3) for managing partitions.

In the branching processing, if an “accessible” partition is set “inaccessible”, the following processes are performed.

First, the attribute of the desired partition stored in the management table is changed into an attribute (for example, “empty drive”) of not being accessed by the OS (S15).

Next, information on the desired partition is reacquired by the OS, and a logical drive corresponding to the partition is unmounted (S16).

By the processes of S15 and S16, the OS can recognize that the desired partition is inaccessible.

Next, an access restriction command is issued to the storage device, and the above-described desired partition is set inaccessible (S17). Access restriction information (information indicating inaccessibility) is thereby set in the storage device itself.

Although access restriction can be performed only by the processes of S15 and S16, the responding and processing functions of the storage device for a read command and a write command can be executed. By the process of S17, the responding and processing functions of the storage device for a read command and a write commend are also prohibited, and higher security can be achieved.

In this case, the process of S17 corresponds to the above-described first process, and the processes of S15 and S16 correspond to the above-described second process.

On the other hand, in the branching processing, if an “inaccessible” partition is set “accessible”, the following processes are performed.

First, an access restriction command is issued to the storage device, and the above-described desired partition is set accessible (S18). Access restriction information (information indicating accessibility) is thereby set in the storage device itself.

Next, the attribute of the desired partition stored in the management table is changed into an attribute (for example, “NTFS”) of being accessed by the OS (S19). In this case, a change is made in a preset original attribute. The original attribute is stored in a predetermined area of the storage unit 42.

Then, information on the desired partition is reacquired by the OS, and a logical drive corresponding to the partition is mounted (S20).

By the processes of S19 and S20, the OS can recognize that the desired partition is accessible.

In this case, the process of S18 corresponds to the above-described first process, and the processes of S19 and S20 correspond to the above-described second process.

As a method of causing the OS to reacquire information on the partition, it suffices that a partition information reacquisition application programming interface (API) is called. If a partition information reacquisition API is not mounted on the OS, it suffices that an API for unmounting the logical drive is called. In addition, if a partition information reacquisition API is not mounted on the OS, a computer may be rebooted. In this case, the OS acquires partition information after the reboot.

As described above, in the present embodiment, the above described first process and second process are performed on the basis of the storage management software. As a result, access restriction information set in the storage device itself by an access restriction function and predetermined information (information on an attribute of a partition) which is recognizable by the OS can be associated with each other per partition. That is, it is possible to make the storage device and the OS match each other in accessibility or inaccessibility per partition. Therefore, the storage device having an access restriction function per partition can be properly managed.

### Second Embodiment

Next, a second embodiment will be described. Because a basic structure is similar to that of the first embodiment, explanations of the structures described in the first embodiment will be omitted.

A basic structure of a computer system according to the present embodiment is the same as the structure of a computer system 10 shown in FIG. 1. In addition, the structure (layout) of a storage unit 42 shown in FIG. 1 is also the same as the structure shown in FIG. 3. Accordingly, explanations of the computer system and the storage device will be omitted.

FIG. 7 is an illustration schematically showing an access method to the storage device in storage management software. The storage management software accesses the storage device via a device driver included in an OS and a removable-media-setting driver (for example, a removable-disk-setting driver).

In the present embodiment, by the removable-disk-setting driver (removable-media-setting driver), partitions (storage areas) are each recognized as a virtual removable disk (virtual removable media). Further, information on whether a virtual removable disk is in an inserted state or not is recognized by the OS as predetermined information. That is, information on whether a virtual removable media is mounted (set) or not is recognized by the OS as predetermined information. The OS does not access a partition for which a virtual removable disk is not inserted. Therefore, for a partition on which an access restriction based on an access restriction function is put (which is set inaccessible), the OS is made to recognize that a virtual removable disk is not inserted.

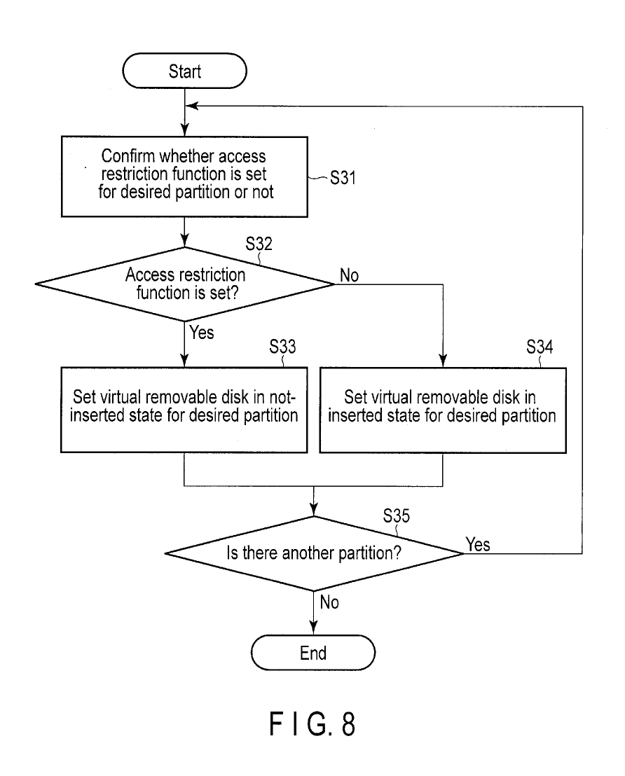

FIG. 8 is a flowchart showing operation at the time of booting the removable-disk-setting driver. The processing of the flowchart of FIG. 8 is performed mainly on the basis of the storage management software.

First, it is confirmed whether an access restriction function is set for a desired partition or not (S31). Next, in accordance with the access restriction function, the following branching processing is performed (S32).

If an access restriction function is set for the desired partition (S32; Yes), a virtual removable disk is set in a not-inserted state for the partition (S33). If an access restriction function is not set for the desired partition (S32; No), a virtual removable disk is set in an inserted state for the partition (S34).

After the above-described setting processing is ended for the desired partition, it is determined whether there is another partition or not (S35). If there is another partition (S35; Yes), the processing returns to the step of S31. If there is no other partition (S35; No), the processing at the time of booting the removable-disk-setting driver is ended.

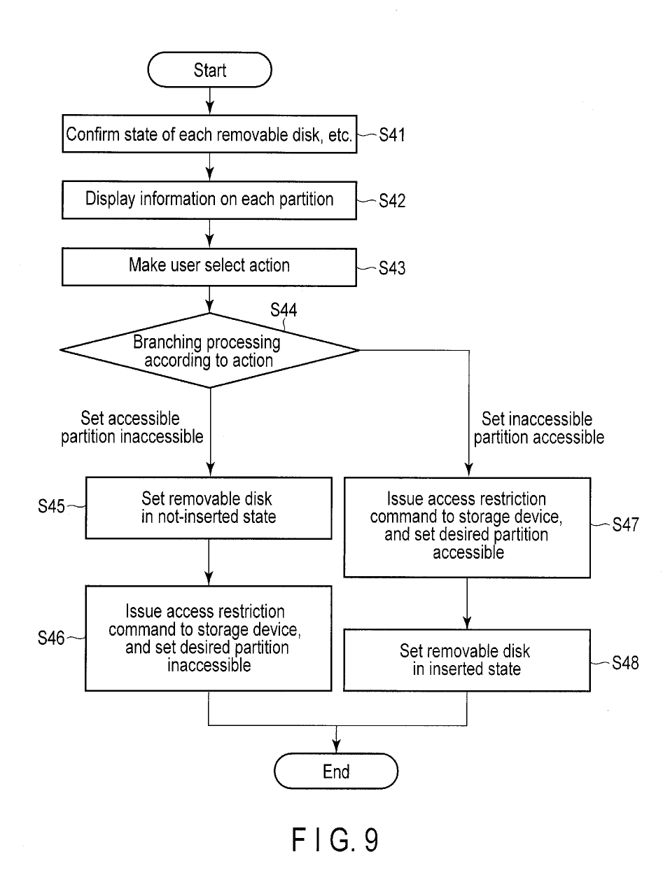

FIG. 9 is a flowchart showing a method (a managing method of a storage device) of the present embodiment. The processing of the flowchart of FIG. 9 is performed mainly on the basis of the storage management software.

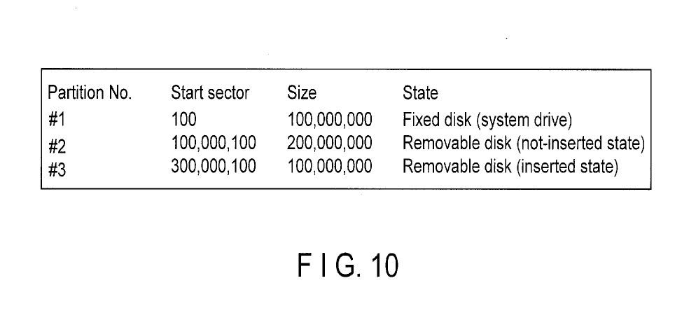

First, when the system is booted, information (information such as a start sector and the size of an area) on each partition and a state (status) of a corresponding removable disk are confirmed (S41). FIG. 10 is an illustration showing an example of partition information and a state of a removable disk.

Next, information on each partition is displayed on a display (S42). Display content on the display is the same as in FIG. 6. If a partition is in a “removable-disk-inserted” state, it is considered that an access restriction is not put on the partition. That is, the partition is considered accessible. If a partition is in a “removable-disk-not-inserted state”, it is considered that an access restriction is put on the partition. That is, the partition is considered inaccessible.

Next, a user is made to select a desired action on the basis of display content on the display (S43).

Then, branching processing according to an action selected by the user is performed (S44). More specifically, in each processing after branching, mainly the following two processes are performed.

A first process is to set access restriction information based on an access restriction function of the storage device for a desired partition (storage area). The access restriction information is information on whether the desired partition is set accessible or is set inaccessible.

A second process is to set predetermined information which indicates whether the desired partition (storage area) is accessible or not and is recognizable by an operating system (OS). In the present embodiment, the predetermined information is information on whether a virtual removable media is mounted (set) or not. That is, the predetermined information is information on whether a virtual removable disk is inserted or not.

In the branching processing, if an “accessible” partition is set “inaccessible”, the following processes are performed.

First, a media-not-inserted-setting command is issued to the removable-disk-setting driver, and a removable disk is set in a not-inserted state (S45). The OS can thereby recognize that the desired partition is inaccessible.

Next, an access restriction command is issued to the storage device, and the desired partition is set inaccessible (S46). Access restriction information (information indicating inaccessibility) is thereby set in the storage device itself.

Although access restriction can be performed only by the process of S45, a read command and a write command of the storage device can be executed. By the process of S46, a read command and a write command of the storage device are also prohibited, and higher security can be achieved.

The process of S46 corresponds to the above-described first process, and the process of S45 corresponds to the above-described second process.

In the branching processing, if an “inaccessible” partition is set “accessible”, the following processes are performed.

First, an access restriction command is issued to the storage device, and the desired partition is set accessible (S47). Access restriction information (information indicating accessibility) is thereby set in the storage device itself.

Next, a media-inserted-setting command is issued to the removable-disk-setting driver, and a removable disk is set in an inserted state (S48). The OS can thereby recognize that the desired partition is accessible.

The process of S47 corresponds to the above-described first process, and the process of S48 corresponds to the above-described second process.

As described above, also in the present embodiment, the above-described first and second processes are performed on the basis of the storage management software. As a result, access restriction information set in the storage device itself by an access restriction function and predetermined information (information on whether a removable media is mounted or not) which is recognizable by the OS can be associated with each other per partition. That is, it is possible to make the storage device and the OS match each other in accessibility or inaccessibility per partition. Therefore, also in the present embodiment, the storage device having an access restriction function per partition can be properly managed.

Although storage management software operates on an OS in the above-described first and second embodiments, the storage management software may operate on a bootloader.

Further, the methods of the above-described first and second embodiments can be provided by a storage medium storing a computer-readable program (program of storage management software). By loading the program stored in the storage medium into an OS, the methods of the above-described first and second embodiments can be implemented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A managing method of a storage device comprising a storage unit capable of being divided into a plurality of storage areas, and being capable of setting an access restriction for each of the storage areas, the method comprising:
setting access restriction information on the access restriction to a desired one of the storage areas; and
setting predetermined information which indicates whether the desired storage area is accessible or not and which is capable of being recognized by a host system.

2. The method of claim 1, wherein the predetermined information is information on an attribute of the desired storage area.

3. The method of claim 1, wherein the predetermined information is set as a part of management information for managing the storage areas.

4. The method of claim 1, wherein
the storage areas are each recognized as a virtual removable media, and
the predetermined information is information on whether the virtual removable media is mounted or not.

5. The method of claim 1, wherein setting the access restriction information or setting the predetermined information are carried out based on software operating on an operating system.

6. The method of claim 1, wherein setting the access restriction information or setting the predetermined information are carried out based on software operating on a bootloader.

7. The method of claim 1, wherein setting the access restriction information or setting the predetermined information are carried out based on an instruction from the host system.

8. The method of claim 1, wherein the storage device is an HDD or an SSD.

9. A computer system comprising:
a storage device comprising a storage unit capable of being divided into a plurality of storage areas, and being capable of setting an access restriction for each of the storage areas; and
a processor configured to set access restriction information on the access restriction for a desired one of the storage areas, and to set predetermined information which indicates whether the desired storage area is accessible or not and which is capable of being recognized by a host system.

10. The computer system of claim 9, wherein the predetermined information is information on an attribute of the desired storage area.

11. The computer system of claim 9, wherein the predetermined information is set as a part of management information for managing the storage areas.

12. The computer system of claim 9, wherein
the storage areas are each recognized as a virtual removable media, and
the predetermined information is information on whether the virtual removable media is mounted or not.

13. The computer system of claim 9, wherein setting the access restriction information or setting the predetermined information are carried out based on software operating on an operating system.

14. The computer system of claim 9, wherein setting the access restriction information or setting the predetermined information are carried out based on software operating on a bootloader.

15. The computer system of claim 9, wherein setting the access restriction information or setting the predetermined information are carried out based on an instruction from the host system.

16. The computer system of claim 9, wherein the storage device is an HDD or an SSD.

17. A computer-readable storage medium configured to store a program for managing a storage device comprising a storage unit capable of being divided into a plurality of storage areas, and being capable of setting an access restriction for each of the storage areas, the program causing the computer to:
set access restriction information on the access restriction for a desired one of the storage areas; and
set predetermined information which indicates whether the desired storage area is accessible or not and which is capable of being recognized by a host system.

18. The storage medium of claim 17, wherein the predetermined information is information on an attribute of the desired storage area.

19. The storage medium of claim 17, wherein the predetermined information is set as a part of management information for managing the storage areas.

20. The storage medium of claim 17, wherein
the storage areas are each recognized as a virtual removable media, and
the predetermined information is information on whether the virtual removable media is mounted or not.
